(19) United States
(12) Patent Application Publication
(10) Pub. No.: US 2026/0088734 A1
(43) Pub. Date: Mar. 26, 2026

(54) CONVERTING DEVICE AND METHOD OF CONTROLLING THE SAME

(71) Applicant: AcLeap Power Inc., Taipei City (TW)

(72) Inventors: Wen Luo, Shanghai City (CN); Zhongmin Huang, Shanghai City (CN); Jie Xu, Shanghai City (CN)

(21) Appl. No.: 18/965,454

(22) Filed: Dec. 2, 2024

(30) Foreign Application Priority Data
Sep. 24, 2024 (CN) 202411331680.5

(51) Int. Cl. H02M 7/5395; H02M 7/5387

(52) U.S. Cl. CPC H02M 7/5395; H02M 7/53873

(57) ABSTRACT

A method of controlling a converting device includes connecting a first transistor coupled to a first node and a second transistor coupled to a second node to generate a primary current flowing from the first node through a primary coil to the second node, generating a secondary current according to the primary current to power a load, and during a delayed time when the second transistor is disconnected, powering the second node through the first transistor. A converting device includes a first transistor coupled to a first node, a second transistor coupled to a second node, and an input power source configured to generate a primary current that flows from the first node through a primary coil to the second node, wherein when the second transistor is disconnected, power the second node through the first transistor by the input power source.

### CROSS-REFERENCE TO RELATED APPLICATIONS

This application claims priority to Chinese Patent Application No. 202411331680.5, filed Sep. 24, 2024 and titled “CONVERTING DEVICE AND METHOD OF CONTROLLING THE SAME” which is herein incorporated by reference in its entirety.

### BACKGROUND

A common non-isolated full bridge converter has a better converting efficiency and reliability compared to buck converter. However, during the controlling process of the common non-isolated full bridge converter, an uncontrollable node voltage is generated. The uncontrollable node voltage will result in a voltage of two terminals of a transistor being too high, and it is required to deploy a Metal Oxide Semiconductor Field-Effect Transistor (MOSFET) with higher voltage loading. When deploying a higher voltage loading MOSFET, the power consumption of the converter circuit will increase.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a circuit diagram illustrating a converting device according to some embodiments of the disclosure.

FIG. 2 is a timing diagram illustrating the control of a converting device according to some embodiments of the disclosure.

FIG. 3A is a circuit diagram illustrating a converting device according to some embodiments of the disclosure.

FIG. 3B is a circuit diagram illustrating a converting device according to some embodiments of the disclosure.

FIG. 3C is a circuit diagram illustrating a converting device according to some embodiments of the disclosure.

FIG. 3D is a circuit diagram illustrating a converting device according to some embodiments of the disclosure.

FIG. 4A is a schematic diagram illustrating the operation of a converting device according to some embodiments of the disclosure.

FIG. 4B is a schematic diagram illustrating the operation of a converting device according to some embodiments of the disclosure.

FIG. 4C is a schematic diagram illustrating the operation of a converting device according to some embodiments of the disclosure.

FIG. 4D is a schematic diagram illustrating the operation of a converting device according to some embodiments of the disclosure.

FIG. 5 is an operating flow chart diagram illustrating the method of controlling a converting device according to some embodiments of the disclosure.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

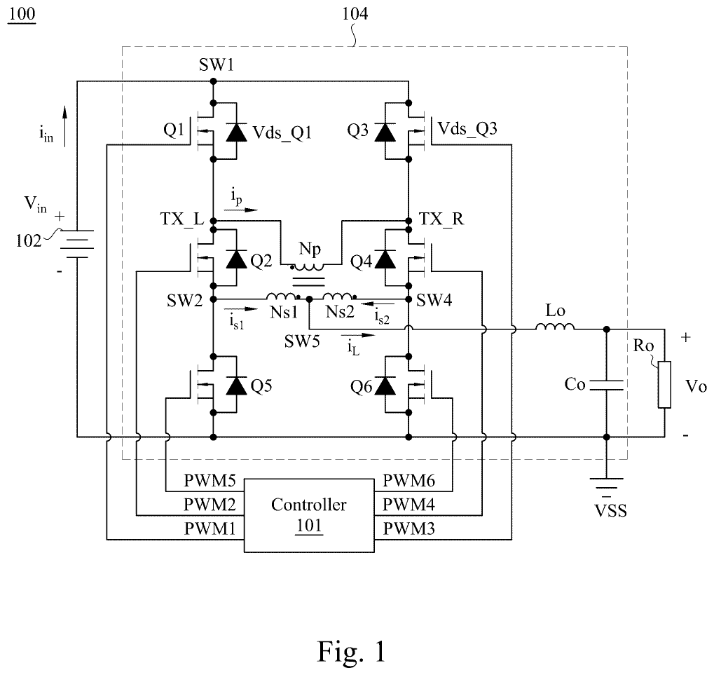

FIG. 1 is a circuit diagram illustrating a converting device 100 according to some embodiments of the disclosure. As shown in FIG. 1, the converting device 100 includes a controller 101, an input power source 102, an output load 103, and a converter 104. The input power source 102 is configured to provide an input voltage Vᵢₙ. The converter 104 is configured to receive the input voltage Vᵢₙ and provide an output voltage Vo according to signals PWM1-PWM6. The controller 101 is configured to generate multiple signals PWM1-PWM6 to control the converter 104. The output load 103 is configured to receive the output voltage Vo. The converter 104 includes multiple transistors Q1-Q6, a primary coil NP, secondary coils Ns1 and Ns2, an inductor Lo, and a capacitor Co.

In some embodiments, the transistors Q1-Q6 can be implemented by the Metal Oxide Semiconductor Field-Effect Transistor (MOSFET). In some embodiments of the disclosure, the transistors Q1-Q6 can be implemented by N-type MOSFET, wherein each of the transistors Q1-Q6 includes one body diode. The converter 104 is a full bridge converting circuit which includes the controlling of the transistors Q1-Q6 and the converting circuit can be implemented by the non-isolated full bridge converter.

As shown in FIG. 1, a first terminal of the transistor Q1 is coupled to a positive terminal of the input power source 102, and is configured to receive the input voltage Vᵢₙ. A terminal of the transistor Q1 and a terminal of the transistor Q2 are coupled in series to a node TX_L. The gate terminals of the transistors Q1-Q6 are configured to receive the signals PWM1-PWM6 respectively. In some embodiments, a terminal of the transistor Q3 is coupled to the positive terminal of the input power source 102, and is configured to receive the input voltage Vᵢₙ. A terminal of the transistor Q3 and a terminal of the transistor Q4 are coupled in series to a node TX_R. Another terminal of the transistor Q2 and a terminal of the transistor Q5 are coupled in series to a node SW2. Another terminal of the transistor Q4 and a terminal of the transistor Q6 are coupled in series to a node SW4.

As shown in FIG. 1, the secondary coil Ns1 and the secondary coil Ns2 are coupled in series to a node SW5, and three of the secondary coil Ns1, the secondary coil Ns2, and the primary coil Np are coupled by magnetic induction. A terminal of the primary coil Np is coupled to the node TX_L, and the other terminal of the primary coil Np is coupled to the node TX_R. A terminal of the secondary coil Ns1 is coupled to the node SW2, and a terminal of the secondary coil Ns2 is coupled to the node SW4. A terminal of the inductor Lo is coupled to the node SW5, and the other terminal of the inductor Lo is coupled to a terminal of the capacitor Co and a positive terminal of the output load 103. The other terminal of the capacitor Co is configured to receive a reference voltage signal Vss, and coupled to a negative terminal of the input power source 102. In some embodiments, the reference voltage signal Vss has ground voltage level.

In some embodiments, when the converter 104 is operating, the input power source 102 is configured to apply the input voltage to the transistor Q1 to generate an input current iᵢₙ. The input current iᵢₙ flows through the transistor Q1 so that the two terminals of the transistor Q1 have voltage Vds_Q1. In response to a voltage difference of the node TX_R and TX_L, the converter 104 generates a primary current iₚ. The primary current iₚ flows through the primary coil Np and the transistor Q4 and generates a secondary current iₛ₂ at the node SW4, wherein the secondary current iₛ₂ corresponds to the primary current iₚ that flows through the transistor Q4 and an inducting current generated by the secondary coil Ns2 as a result of the magnetic induction from the primary coil Np.

In some other embodiments, when the converter 104 is operating, the input power source 102 is configured to supply the input voltage Vᵢₙ to the transistor Q3 to generate the input current iᵢₙ. The input current iᵢₙ flows through the transistor Q3 so that the two terminals have a voltage Vds_Q3. In response to a voltage difference of the node TX_R and TX_L, the converter 104 generates a primary current iₚ. The primary current iₚ flows through the primary coil Np and the transistor Q2 and generates a secondary current iₛ₁ at the node SW2, wherein the secondary current iₛ₁ corresponds to the primary current iₚ that flows through the transistor Q2 and an inducting current generated by the secondary coil Ns1 as a result of the magnetic induction from the primary coil Np.

In some embodiments, in response to the secondary current iₛ₂ generated by the node SW4 and the secondary current iₛ₁ generated by the node SW2, an exciting current i_{L} is generated at the node SW5. The exciting current i_{L} flows through the inductor Lo, the capacitor Co and is provided to the load 103 as an output current.

In some embodiments, when the transistors Q1-Q4 is connected or disconnected, the voltage of the node TX_L or the voltage of the node TX_R of the converter 104 is floating between the reference voltage Vss and the input voltage Vᵢₙ.

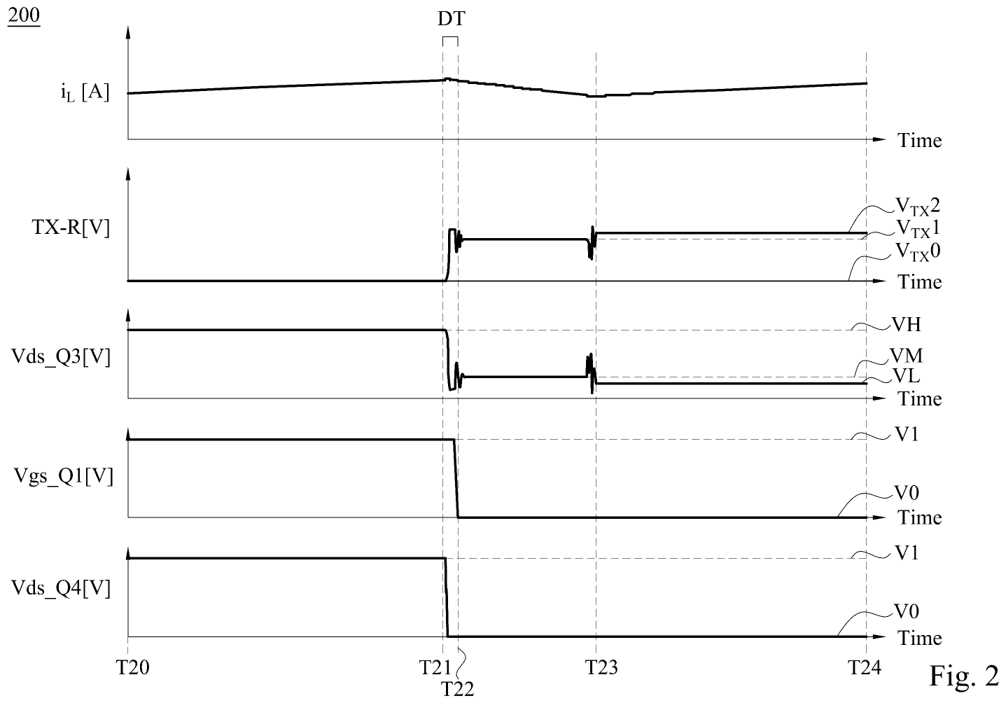

In some embodiments, when the voltage of the node TX_L or the voltage of the node TX_R is higher, the voltages of two terminals of both of the transistors Q1 and Q3 of the converter 104 are lower than their rated voltages respectively, the converter 104 is able to operate normally. However, when the voltage of the node TX_L or the voltage of the node TX_R is lower, the voltages of two terminals of both of the transistors Q1 and Q3 of the converter 104 are higher than their rated voltages respectively, it is required to substitute the transistors of the converter 104 with transistors having higher loading voltage, which generates more power consumption. The disclosure provides a controlling method which can effectively adjust the voltage of the node TX_L and the voltage of the node TX_R, and decrease the power consumption of the converter 104 by using the transistors with lower loading voltage. The specific implementation and the controlling method will be discussed in detailed from FIG. 2 to FIG. 5 and corresponding paragraphs of the disclosure.

FIG. 2 is a timing diagram illustrating the control of the converting device 100 according to some embodiments of the disclosure. As shown in FIG. 2, the timing diagram 200 illustrates the operation of the converting device 100 during the time T20 to T24.

Please refer to FIG. 1 and FIG. 2, the timing diagram 200 illustrates the changes of the exciting current i_{L}, the voltage of the node TX_R, the voltage Vds_Q3, the voltage Vgs_Q1, and the voltage Vgs_Q4 with respect to time. Wherein the voltage Vgs_Q1 is a voltage between a gate terminal and a first terminal of the transistor Q1, that is, the voltage between the gate terminal of the transistor Q1 and the node SW1. The voltage Vds_Q3 is a voltage between two terminals of the transistor Q3, that is, the voltage between the node TX_R and the node SW1. The voltage Vgs_Q4 is a voltage between a gate terminal and a first terminal of the transistor Q4, that is, the voltage between the gate terminal of the transistor Q4 and the node SW4.

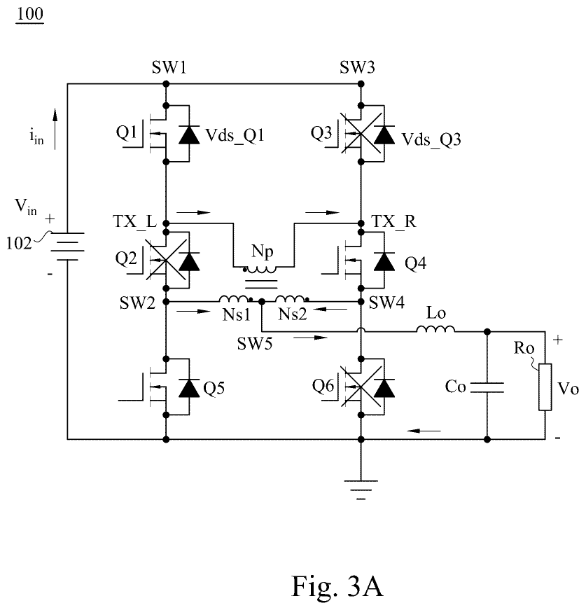

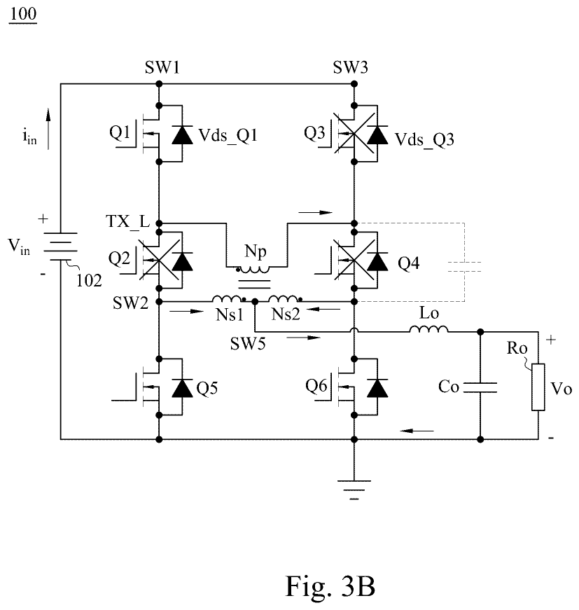

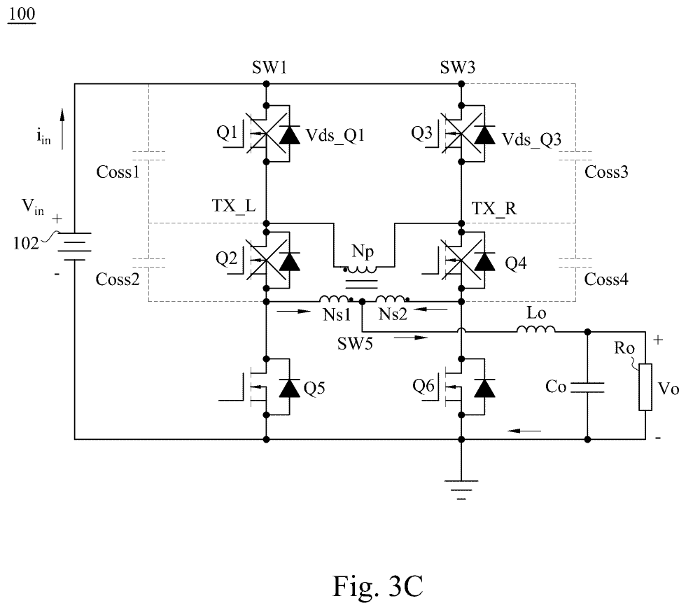

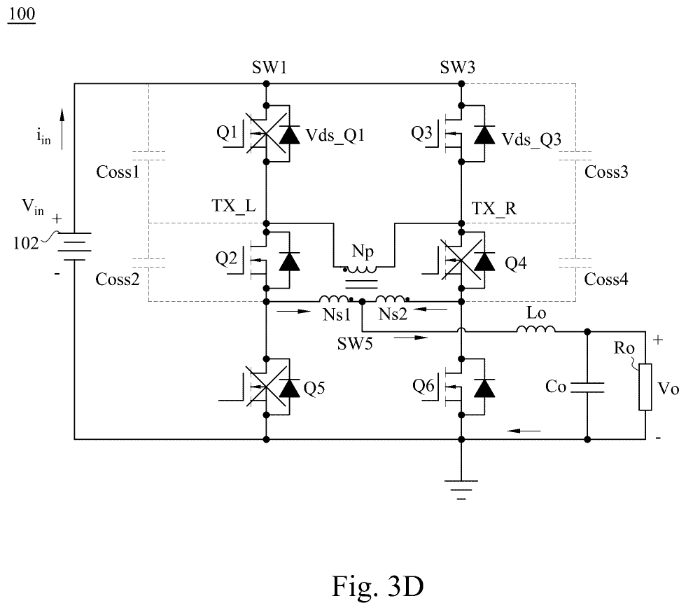

FIG. 3A to FIG. 3D are circuit diagrams illustrating the operation of the converting device 100 during different periods of time according to some embodiments of the disclosure. FIG. 3A corresponds to the period between time T20 and T21. FIG. 3B corresponds to the period between time T21 and T22. FIG. 3C corresponds to the period between time T22 and T23. FIG. 3D corresponds to the period between time T23 and T24.

Please refer to FIG. 2 and FIG. 3A, during the period between T20 and T21, each of the signals PWM1 and PWM2 has a turn-on voltage level so that each of the transistors Q1 and Q4 remains connected. Each of the signals PWM2 and PWM3 has a turn-off voltage level so that each of the transistors Q2 and Q3 remains disconnected. At this moment, each of the voltage Vgs_Q1 and Vgs_Q4 has a voltage level V1 corresponding to the turn-on voltage level.

During the period between T20 and T21, the input power source 102 provides the input voltage Vᵢₙ to the first terminal of the transistor Q1 so that the node SW1 has a voltage level being the same as the input voltage Vᵢₙ. The input current iᵢₙ flows from the input power source 102 through the transistor Q1. The primary current iₚ flows from the node TX_L through the primary coil Np to the node TX_R so that the node TX_R has a voltage level V_{TX}0, and the second terminal of the transistor Q3 has the voltage level V_{TX}0. The primary current iₚ flows from the node TX_R through the transistor Q4 to the node SW4. The secondary current iₛ₁ flows from the node SW2 through the secondary coil Ns1 to the node SW5. The secondary current iₛ₂ flows from the node SW2 through the secondary coil Ns2 to the node SW5. The secondary current iₛ₁ and iₛ₂ are added at the node SW5 to generate the exciting current i_{L}. The exciting current i_{L} flows through the inductor Lo and provides power to the load 103.

At this moment, in response to the transistor Q4 is connected, electric charges flows from the node TX_R through the transistor Q4 to the node SW4 so that the voltage Vds_Q3 has a voltage level VH. In response to the primary current iₚ increased, the exciting current i_{L} remains increasing.

Then, at time T21, the signal PWM4 switches from the turn-on voltage level to the turn-off voltage level so that the voltage Vgs_Q4 has voltage level V0 and the transistor Q4 is disconnected. On the other side, the signal PWM1 remains at the turn-on voltage level so that the voltage Vgs_Q1 has voltage level V1 and the transistor Q1 remains connected.

At this moment, the primary current iₚ flows from the node TX_L through the primary coil Np to the node TX_R, and starts charging a parasitic capacitor Coss_Q4 of the transistor Q4. The voltage V_{coss_Q4} between two terminals of the parasitic capacitor Coss_Q4 starts increasing when charging the parasitic capacitor Coss_Q4. When the transistor Q4 is disconnected, the primary current iₚ stops flowing from the transistor Q4 to the node SW4. Therefore, the secondary current iₛ₁ of the secondary coil Ns1 starts decreasing, and the exciting current i_{L} generated at node SW5 starts decreasing correspondingly.

Please refer to FIG. 2 and FIG. 3D, during the period between time T21 and T22, the signal PWM4 remains at the turn-off voltage level, the voltage Vgs_Q4 has voltage level V0, and the transistor Q4 remains disconnected. Respectively, the signal PWM1 remains at the turn-on voltage level, the voltage Vgs_Q1 has voltage level V1, and the transistor Q1 remains connected.

During the period between time T21 and T22, in response to the primary current iₚ is charging the parasitic capacitor Coss_Q4, the node TX_R next to a terminal of the parasitic capacitor Coss_Q4 rapidly increases from the voltage level V_{TX}0 to the voltage level V_{TX}2. In response to the node TX_R rapidly increases from the voltage level V_{TX}0 to the voltage level V_{TX}2, the voltage Vds_Q3 of two terminal of the transistor Q3 decreases to the voltage level VL. At this moment, in response to the voltage V_{coss_Q4} remains increasing, the voltage of the node SW4 is increased and greater than the voltage of the node SW2. In some embodiments, the voltage of the node TX_R can be lower than the voltage Vds_Q3. In some other embodiments, the voltage of the node TX_R can also be greater than the voltage Vds_Q3.

Then, at time T22, the signal PWM1 switches from the turn-on voltage level to the turn-off voltage level, so that the voltage Vgs_Q1 has the voltage level V0 and the transistor Q1 is disconnected. At this moment, each of the signal PWM2-PWM4 remains at turn-off voltage level so that each of the voltage Vgs_Q2, Vgs_Q3, and Vgs_Q4 has the voltage level V0 and each of the transistors Q2-Q4 remains disconnected. At this moment, the voltage of the node TX_R is increased to the voltage level V_{TX}2. In response to the voltage of the node TX_R has the voltage level V_{TX}2, the voltage Vds_Q3 is decreased to voltage level VL. Wherein the voltage level VL is lower than the voltage level V_{TX}2. In response to the transistor Q1 is disconnected, the input power source 104 stop charging the node TX_R so that the parasitic capacitor Coss_Q4 starts discharging at time T22.

In some embodiments, the period between time T21 and T22 can be called a delay time DT. After the delay time DT, the voltage of the node TX_R increases, and the voltage Vds_Q3 decreases correspondingly. After the delay time DT, the signal PWM1 has turn-off voltage level at time T22, so that the voltage Vgs_Q1 has voltage level V0 and the transistor Q1 is disconnected.

For example, during the period between time T21 and T22, when the input voltage Vᵢₙ has voltage level 60V and after the delay time DT, the voltage of the node TX_R is increased to voltage level 50V. At this moment, the voltage Vds_Q3 has voltage level 10V, and the transistor Q1 is disconnected by the signal PWM1. In some embodiments, the delay time DT can be 10 nanoseconds, but the disclosure is not limited to this timing. In some embodiments, the delay time DT can be adjusted according to a default voltage, but the disclosure is not limited to this timing.

In some embodiments, the duration of the period between time T21 and T22 is determined by the voltage of the node TX_R, that is, the duration of the time that the voltage of the node TX_R increases from the voltage level V_{TX}0 to the default voltage level. When the voltage of the node TX_R has the default voltage level, the signal PWM1 has the turn-off voltage level at time T22, so that the voltage Vgs_Q1 has voltage level V0 and the transistor Q1 is disconnected. In some embodiments, the default voltage level is equal to the voltage level V_{TX}2.

For example, at time T21, the input voltage has a voltage level of 60V and the default voltage has a voltage level of 50V. The time that the voltage of the node TX_R increased to voltage level of 50V corresponds to time T22. At this moment, the transistor Q1 is disconnected by signal PWM1, and in response to the voltage of the node TX_R, the voltage Vds_Q3 has voltage level of 10V.

Please refer to FIG. 2 and FIG. 3C, during the period of time T22 and T23, the voltages of the signals PWM1 and PWM4 remain having turn-off voltage level, each of the voltages Vgs_Q1 and Vgs_Q4 has voltage level V0 and the transistors Q1 and Q4 remain disconnected.

During the period of time T22 and T23, the input current iᵢₙ stops flowing from the input power source 102 to the transistor Q1, so that the converter 104 is cut-off, and the exciting current i_{L} decreases gradually. The parasitic capacitor Coss_Q4 after charged starts discharging, so that the voltage of the node TX_R is decreasing, having a voltage level V_{TX}1 which is greater than the voltage level V_{TX}0 and lower than the voltage level V_{TX}2. In response to the voltage of the node TX_R is decreased to the voltage level V_{TX}1, the voltage Vds_Q3 increases to a voltage level VM which is greater than the voltage level VL and lower than the voltage level VH. Wherein the voltage level VM is lower than the voltage level V_{TX}1.

At this moment, the electric charges flow from the parasitic capacitor Coss_Q4 which remains discharging through the node TX_R to the node TX_L, resulting in a balance of electric charges. Each of the nodes TX_L and TX_R with neutral electric charges has the same voltage level V_{TX}1. The secondary currents iₛ₁ and iₛ₂ flow from the node SW2 and the node SW4 to the node SW5 respectively, so that the voltages of the node SW2 and SW4 decrease to 0V.

At time T23, each of the signals PWM2 and PWM3 switches to the turn-on voltage level, so that each of the transistors Q2 and Q3 is connected. Each of the signals PWM1 and PWM4 has turn-off voltage level, so that each of the transistors Q1 and Q4 remains disconnected. At this moment, each of the voltages Vgs_Q2 and Vgs_Q3 has the voltage level V1 corresponds to the turn-on voltage level, respectively.

At this moment, the input power source 102 starts supplying power to the converter 104, and provides the input voltage Vᵢₙ to the first terminal of the transistor Q3. The input current iᵢₙ starts flowing from the input power source 102 through the transistor Q3. The transistor Q3 is connected so that the exciting current i_{L} starts increasing.

During the period of time T23 and T24, the input power source 102 keeps supplying the input voltage Vᵢₙ to the first terminal of the transistor Q3, so that the node SW3 has the same voltage level as the input voltage Vᵢₙ. The input current iᵢₙ flows from input power source 102 to the transistor Q3. The primary current iₚ flows from the node TX_R through the primary coil Np to the node TX_L, so that the node TX_L has the voltage level V_{TX}0, and the second terminal of the transistor Q1 has the same voltage level V_{TX}0 as the node TX_L. the primary current iₚ flows from the node TX_L through the transistor Q2 to the node SW2. The secondary current iₛ₁ flows from the node SW4 through the secondary coil Ns1 to the node SW5. The secondary current iₛ₂ flows from the node SW2 through the secondary coil Ns2 to the node SW5. The secondary current iₛ₁ and iₛ₂ add up at the node SW5 to generate the exciting current i_{L}. The exciting current i_{L} flows through the inductor Lo to supply power to the load 103.

At this moment, in response to the transistor Q2 is connected, electric charges flows form the node TX_L through the transistor Q2 to the node SW2, so that the voltage Vds_Q1 has the voltage level VH, and the node TX_L has the voltage level V_{TX}0. The voltage Vds_Q1 is the voltage of two terminals of the transistor Q1, that is, the voltage between the node SW3 and TX_L. In response to the primary current iₚ increased, the exciting current i_{L} keeps increasing.

In some embodiments, the period between time T20 and T24 represents a half period cycle. The operations of the transistors Q1-Q4 of the converter 104 during a period different from the period between T20 and T24 is similar. Operations similar to the operations between time T20 and T24 can be extended after time T24.

Specifically, the duration from time T20, the transistors Q1 and Q1 remain connected and the transistors Q2 and Q3 remains disconnected, to time T24, the transistors Q2 and Q3 remain connected and the transistors Q1 and Q1 remains disconnected, represents a half period cycle. After time T24, the converting device 100 can repetitively extend multiple operations which are the same as the period between time T20 and T24, only the connecting and disconnecting of the transistors Q1 and Q4 and the connecting and disconnecting of the transistors Q2 and Q3 are inversely related, respectively.

In some embodiments, the operations during the period between time T20 and T24 can be repetitively performed after time T24. For example, after time T24, the transistor Q3 remain connected and the transistor Q2 is disconnected. Then, both of the transistors Q2 and Q3 are disconnected. Then, both of the transistors Q1 and Q4 are connected at the same time.

In some different embodiments, during the period between time T21 and T22, the disconnecting orders of the transistors Q1 and Q4 can be swapped. Specifically, at time between time T21 and T22, the transistor Q4 is connected and the transistor Q1 is disconnected, and after the delay time DT, the transistors Q1 and Q4 are disconnected at the same time.

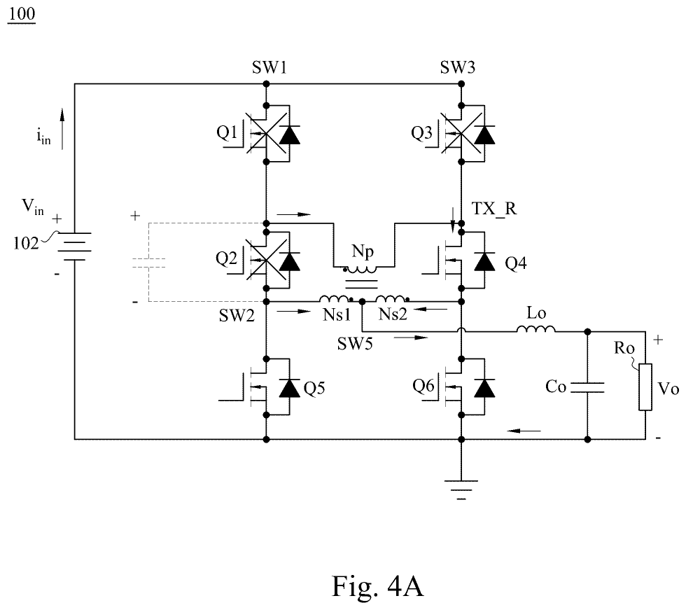

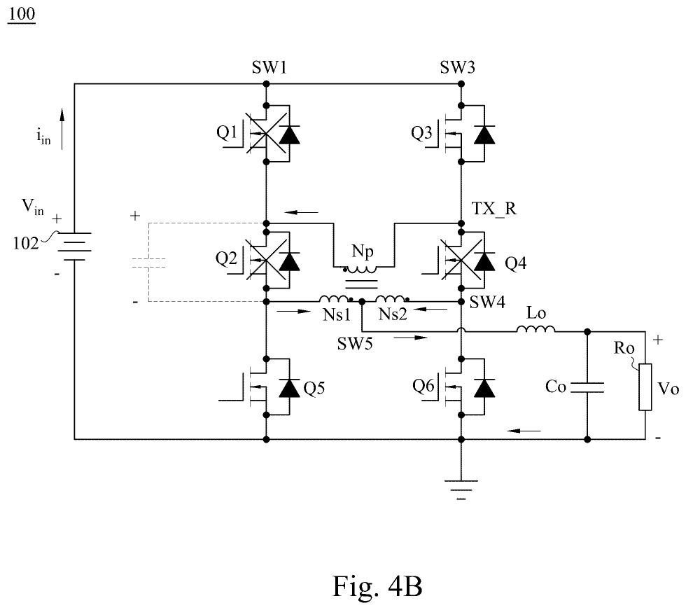

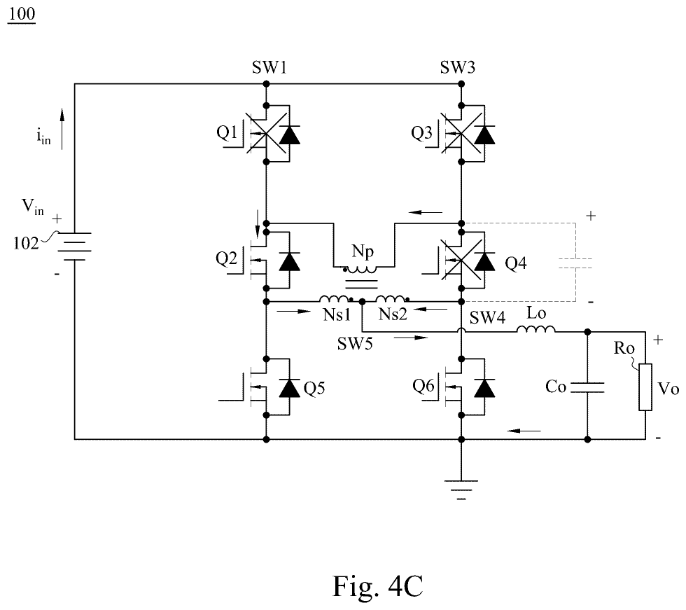

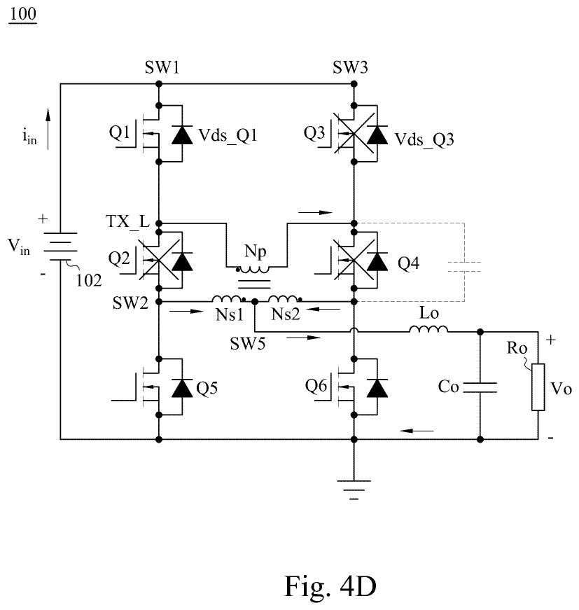

FIG. 4A is a schematic diagram illustrating the operation of the converting device 100 according to some embodiments of the disclosure. Please refer to FIG. 2 and FIG. 4A, the operation of the converting device 100 shown in FIG. 4A corresponds to another embodiment of the operation during the period between time T21 and T22 in FIG. 2.

In the embodiment in FIG. 4A, at time T21, each of the signals PWM2 and PWM3 remains at the turn-off voltage level, so that each of the voltages Vgs_Q2 and Vgs_Q3 has the voltage level V0 and the transistors Q2 and Q3 are disconnected. The signal PWM1 switches from the turn-on voltage level to the turn-off voltage level, so that the voltage Vgs_Q1 has the voltage level V0 and the transistor Q1 is disconnected. Relatively, the signal PWM4 remains at the turn-on voltage level, so that the voltage Vgs_Q4 has voltage level V1 and the transistor Q4 remains connected.

At this moment, the parasitic capacitor Coss_Q2 of the transistor Q2 is discharging so that the voltage V_{coss_Q2} of two terminal of the parasitic capacitor Coss_Q2 starts decreasing. When the transistor Q1 is disconnected, the input current iᵢₙ stop flowing through the transistor Q1 to the node TX_L, so the voltage of the node TX_L starts decreasing. In response to the transistor Q1 is disconnected, the primary current iₚ which flows through the primary coil Np is correspondingly decreasing, so the voltage of the node TX_L starts decreasing. Relatively, the secondary current iₛ₁ of the secondary coil Ns1 starts decreasing, and the exciting current i_{L} generated at node SW5 starts decreasing.

During the period between time T21 and T22, each of the nodes TX_L and TX_R decrease from the voltage level V_{TX}0 to the voltage level V_{TX}3. Wherein the voltage level V_{TX}3 is lower than the voltage level V_{TX}0. In response to the decreasing voltage of the node TX_L, the voltage Vds_Q3 of two terminals of the transistor Q3 keeps increasing. In response to the discharging of the parasitic capacitor Coss_Q2, the voltage of the node SW2, which is on the other side of the parasitic capacitor Coss_Q2, is lower than the voltage of the node SW4. In other words, refer to FIG. 3B and FIG. 4A, during the delay time DT, the converter 104 can perform one of the two operations. With respect to the operation in FIG. 3B, charging the node TX_R by the transistor Q1 to increase the voltage of the node TX_R. in some embodiments, by increasing the voltage of the node TX_R, the stress of the transistors Q1 and Q3 can be decreased. With respect to the operation in FIG. 4A, discharging the node TX_L by the transistor Q4 to decrease the voltage of the node TX_L. In some embodiments, by decreasing the voltage of the node TX_L, the stress of the transistors Q2 and Q4 can be decreased.

Then, at time T22, the signal PWM3 switches from the turn-on voltage level to the turn-off voltage level so that the voltage Vgs_Q4 has the voltage level V0 and the transistor Q4 is disconnected. At this moment, each of the signals PWM1-PWM3 remains at the turn-off voltage level, so that each of the voltages Vgs_Q1-Vgs_Q3 have the voltage level V0 and each of the transistors Q2-Q4 is disconnected.

FIG. 4B is a schematic diagram illustrating the operation of the converting device 100 according to some embodiments of the disclosure. In some embodiments, the operation shown in FIG. 4B can be performed after the time T24 in FIG. 2.

In the embodiment in FIG. 4B, each of the signals PWM1 and PWM4 remains in the turn-off voltage level so that each of the voltages Vgs_Q1 and Vgs_Q4 has voltage level V0 and each of the transistors Q1 and Q4 remains disconnected. The signal PWM2 switches from the turn-on voltage to the turn-off voltage level so that the voltage Vgs_Q2 has voltage level V0 and the transistor Q2 is disconnected. Relatively, the signal PWM3 remains at the turn-on voltage level so that the voltage Vgs_Q3 has voltage level V1 and the transistor Q3 remain connected.

At this moment, the primary current iₚ flows from the node TX_R through the primary coin Np to the node TX_L and starts charging the parasitic capacitor Coss_Q2 of the transistor Q2. The voltage V_{coss_Q2} of two terminals of the parasitic capacitor Coss_Q2, which is being charged, starts increasing. When the transistor Q2 is disconnected, the primary current iₚ stop flowing through the transistor Q2 to the node SW2. Relatively, the secondary current iₛ₂ of the secondary coil Ns2 starts decreasing, and the exciting current i_{L} generated at the node SW5 starts decreasing correspondingly.

Then, when the parasitic capacitor Coss_Q2 is charging, the voltage of the node TX_L is rapidly increased from the voltage level V_{TX}0 to the voltage level V_{TX}2. In response to the voltage of the node TX_L rapidly increased to the voltage level V_{TX}2, the voltage Vds_Q1 of two terminals of the transistor Q1 is decreased to the voltage level VL, which is lower than the voltage level V_{TX}2. At this moment, in response to the increasing voltage V_{coss_Q2}, the voltage of the node SW2 increased, and is higher than the voltage of the node SW4.

When the voltage of the node TX_L is increased to the voltage level V_{TX}2, the signal PWM3 switches from the turn-on voltage level to the turn-off voltage level, so that the voltage Vgs_Q3 has voltage level V0 and the transistor Q3 is disconnected. At this moment, the signals PWM1, PWM2, and PWM4 remain at the turn-off voltage level, so that each of the voltages Vgs_Q1, Vgs_Q2, and Vgs_Q4 has the voltage level V0 and the transistors Q1, Q2, and Q3 remain disconnected.

After the transistor Q3 is disconnected, electric charges flow from the node TX_L to the node TX_R by the parasitic capacitor Coss_Q2, which remains discharging, resulting in a balance of electric charges of the nodes TX_L and TX_R. Each of the nodes TX_L and TX_R with neutral electric charges has the same voltage level V_{TX}1. The secondary currents iₛ₁ and iₛ₂ flow from the node SW2 and the node SW4 to the node SW5 respectively, so that the voltages of the node SW2 and SW4 decrease to 0V.

FIG. 4C is a schematic diagram illustrating the operation of the converting device 100 according to some embodiments of the disclosure. In some embodiments, FIG. 4C illustrates an operation which is another embodiment of FIG. 4B, and the operation can be performed after time T24 in FIG. 2.

In the embodiment in FIG. 4C, each of the signal PWM1 and PWM4 remains at the turn-off voltage level, so that each of the voltages Vgs_Q1 and Vgs_Q4 has voltage level V0 and each of the transistors Q1 and Q4 remains disconnected. The signal PWM3 switches from turn-on voltage level to turn-off voltage level, so that the voltage Vgs_Q3 has voltage level V0 and the transistor Q3 is disconnected. Relatively, the signal PWM2 remains at the turn-on voltage level, so that the voltage Vgs_Q2 has voltage level V1 and the transistor Q2 remains connected.

At this moment, the parasitic capacitor Coss_Q4 of the transistor Q3 is discharging, so that the voltage of two terminals of the parasitic capacitor Coss_Q4 starts decreasing. When the transistor Q3 is disconnected, the input current iᵢₙ stop flowing through the transistor Q3 to the node TX_R, so that the voltage of the node TX_R starts decreasing. When the input current iᵢₙ stop flowing through the primary coil Np, the primary current iₚ of the primary coil decreases, so that the voltage of the node TX_R starts decreasing. Relatively, the secondary current iₛ₂ of the secondary coil Ns2 starts decreasing, and the exciting current i_{L} generated at the node SW5 starts decreasing correspondingly.

Then, each of the nodes TX_R and TX_L keeps decreasing from the voltage level V_{TX}0 to the voltage level V_{TX}3. Wherein the voltage level V_{TX}3 is lower than the voltage level V_{TX}0. In response to the decreasing voltage of the node TX_R, the voltage Vds_Q1 of two terminals of the transistor Q1 remains increasing. In response to the discharging of the parasitic capacitor Coss_Q4, the voltage of the node SW4, which is at the other terminal of the parasitic capacitor Coss_Q4, is lower than the voltage of the node SW2. In other words, refer to FIG. 4B and FIG. 4C, during the delay time DT, the converter 104 can perform one of the two operations. With respect to the operation in FIG. 4B, charging the node TX_L by the transistor Q3 to increase the voltage of the node TX_L. in some embodiments, by increasing the voltage of the node TX_L, the stress of the transistors Q1 and Q3 can be decreased. After duration similar to the duration of the delay time DT, the signal PWM2 switches from the turn-on voltage level to the turn-off voltage level, so that the voltage Vgs_Q2 has the voltage level V0 and the transistor Q2 is disconnected. At this moment, each of the signals PWM1, PWM3, and PWM4 remains at the turn-off voltage level, so that each of the voltages Vgs_Q1, Vgs_Q3, and Vgs_Q4 has voltage level V0 and the transistors Q1, Q3, and Q4 remain disconnected.

FIG. 4D is a schematic diagram illustrating the operation of the converting device 100 according to some embodiments of the disclosure. In some embodiments, FIG. 4D illustrates an operation which can be performed during the period between time T21 and T22 in FIG. 2. In addition, the operation shown in FIG. 4D can also be performed after the operations shown in FIG. 4B or FIG. 4C.

In the embodiment in FIG. 4D, each of the signals PWM2 and PWM3 remains at the turn-off voltage level, so that each of the voltage Vgs_Q2 and Vgs_Q3 has voltage level V0 and each of the transistors Q2 and Q3 is disconnected. The signal PWM4 switches from the turn-on voltage level to the turn-off voltage level, so that the voltage Vgs_Q4 has voltage level V0 and the transistor Q4 is disconnected. Relatively, the signal PWM1 remains at the turn-on voltage level, so that the voltage Vgs_Q1 has the voltage V1 and the transistor Q1 remains connected.

At this moment, the primary current iₚ flows from the node TX_L through the primary coil Np to the node TX_R, and starts charging the parasitic capacitor Coss_Q4 of the transistor Q4. The voltage V_{coss_Q4} of two terminals of the parasitic capacitor Coss_Q4 starts increasing. When the transistor Q4 is disconnected, the primary current iₚ stop flowing through the transistor Q4 to the node SW4. Relatively, the secondary current iₛ₁ of the secondary coil Ns1 starts decreasing, and the exciting current i_{L} generated at the node SW5 starts decreasing correspondingly.

Then, when the parasitic capacitor Coss_Q4 is charging, the voltage of the node TX_R is rapidly increased from the voltage level V_{TX}0 to the voltage level V_{TX}2. In response to the voltage of the node TX_R is rapidly increased to the voltage level V_{TX}2, the voltage Vds_Q3 of two terminal of the transistor Q3 is decreased to the voltage level VL, which is lower than the voltage level V_{TX}2. At this moment, in response to the increasing voltage V_{coss_Q4}, the voltage of the node SW4 increases, and is higher than the voltage of the node SW2.

When the voltage of the node TX_R is increased to the voltage level V_{TX}2, the signal PWM1 switches from the turn-on voltage level to the turn-off voltage level, so that the voltage Vgs_Q1 has voltage level V0 and the transistor Q1 is disconnected. At this moment, each of the signals PWM2-PWM4 remains at the turn-off voltage level, so that the voltages Vgs_Q2, Vgs_Q3, and Vgs_Q4 have voltage level V0 and the transistors Q2-Q4 are disconnected. At this moment, the voltage of the node TX_R is increased to the voltage level V-_{TX}2. In response to the node TX_R has the voltage level V_{TX}2, the voltage Vds_Q3 is decreased to the voltage level VL. In response to the transistor Q1 is disconnected, the input power source 102 stop supplying power to the node TX_R, so that the parasitic capacitor Coss_Q4 starts discharging.

After the transistor Q1 is disconnected, electric charges flow from the node TX_R to the node TX_L by the parasitic capacitor Coss_Q4, which remains discharging, resulting in a balance of electric charges of the nodes TX_L and TX_R. Each of the nodes TX_L and TX_R with neutral electric charges has the same voltage level V_{TX}1. The secondary currents iₛ₁ and iₛ₂ flow from the node SW2 and the node SW4 to the node SW5 respectively, so that the voltages of the node SW2 and SW4 decrease to 0V.

As shown in FIG. 3A to FIG. 4D and FIG. 2, the voltages of the node TX_R and TX_L can be controlled respectively, by controlling the disconnecting orders of each one of the transistors Q1-Q4. Specifically, when the transistors Q4 is firstly disconnected, and secondly disconnect the transistor Q1 after the delay time DT, the voltage of the node TX_R is increased. When the transistors Q1 is firstly disconnected, and secondly disconnect the transistor Q4 after the delay time DT, the voltage of the node TX_R is decreased. When the transistor Q2 is firstly disconnected, and then secondly disconnects the transistor Q3 after duration similar to the delay time DT, the voltage of the node TX_L is increased. When the transistor Q3 is firstly disconnected, and secondly disconnects the transistor Q3 after duration similar to the delay time DT, the voltage of the node TX_L is decreased.

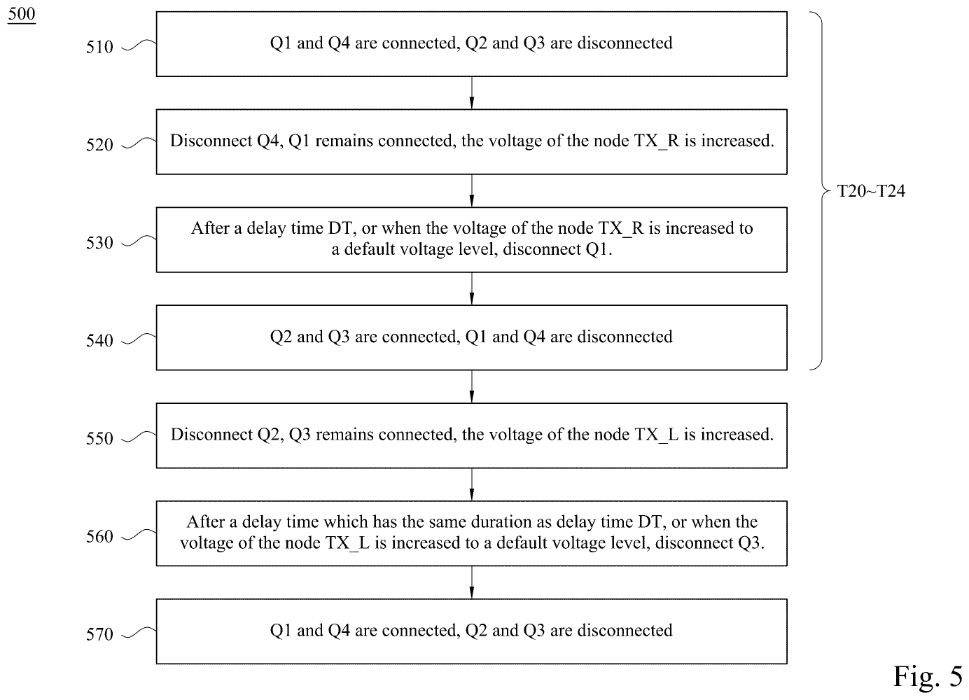

FIG. 5 is an operating flow chart 500 illustrating the method of controlling a converting device 100 according to some embodiments of the disclosure. As shown in FIG. 5, the operating flow chart 500 includes operations 510-570.

Please refer to FIG. 5 and FIG. 2, the operation 510 corresponds to the time T20-T21 in FIG. 2. The operation 520 corresponds to the time T21-T22 in FIG. 2. The operation 530 corresponds to the time T22-T23 in FIG. 2. The operation 540 corresponds to the time T23-T24 in FIG. 2.

In operation 510, the controller 101 keeps the transistors Q1 and Q4 connected by maintaining the signals PWM1 and PWM4 at the turn-on voltage level respectively, and keeps the transistors Q2 and Q3 disconnected by maintaining the signals PWM1 and PWM4 at the turn-off voltage level respectively.

At this moment, each of the voltage Vgs_Q1 and Vgs_Q4 has the voltage level V1, and each of the voltage Vgs_Q2 and Vgs_Q3 has the voltage level V0. The voltage of the node TX_R has the voltage level V_{TX}0, and the voltage Vds_Q3 has the voltage level VH. The converting device 100 continues to operation 520 after completing operation 510.

In operation 520, the controller 101 switches the signal PWM4 to the turn-off voltage level, so that the voltage Vgs_Q4 has voltage level V0 and the transistor Q4 is disconnected.

At this moment, the Vgs_Q1 has the voltage level V1, and each of the voltage Vgs_Q2 and Vgs_Q3 has voltage level V0. The voltage of the node TX_R has the voltage level V_{TX}2, and the voltage Vds_Q3 has voltage level VL. The converting device 100 continues to operation 530 after completing operation 520.

In operation 530, the controller 101 is configured to switch the signal PWM1 to the turn-off voltage level when the voltage of the node TX_R has increased to the reference voltage level after the delay time DT, so that the voltage Vgs_Q1 has the voltage level V0 and the transistor Q1 is disconnected.

At this moment, each of the voltages Vgs_Q2-Vgs_Q4 has voltage level V0. The voltage of the node TX_R has the voltage level V_{TX}1, and the voltage Vds_Q3 has the voltage level VM. The converting device 100 continues to operation 540 after completing operation 530.

In operation 540, the controller 101 switches the signals PWM2 and PWM3 from the turn-off voltage level to the turn-on voltage level, so that each of the voltages Vgs_Q2 and Vgs_Q3 has voltage level V1 and the transistors Q2 and Q3 are connected.

At this moment, each of the voltages Vgs_Q1 and Vgs_Q3 has voltage level V0. The voltage of the node TX_R has the voltage level V_{TX}2, and the voltage Vds_Q3 has voltage level VH. The converting device 100 continues to operation 550 after completing operation 540.

Operation 540 can also be performed as firstly connecting the transistor Q2, and secondly connecting the transistor Q3 after duration similar to the delay time DT to decrease the reversely recovering voltage in a body diode of the transistor Q5. Relatively, operation 540 can also be performed as firstly connecting the transistor Q3, and secondly connecting the transistor Q2 after duration similar to the delay time DT to decrease the reverse recovering voltage in a body diode of the transistor Q5.

Specifically, in some circumstances, when the transistor Q3 is connected and the transistor Q2 is disconnected, the parasitic capacitor Coss_Q3 is discharging to the node TX_R. In response to the parasitic capacitor Coss_Q3 is discharging to the node TX_R, the voltages of the nodes TX_R and TX_L are increased, and the discharging electric charges charge the parasitic capacitor Coss_Q2. In response to the electric charges charge the parasitic capacitor Coss_Q2, the voltage of the node SW2 starts increasing, so that the voltage of two terminals of the transistor Q5 decreases correspondingly. After the duration similar to the delay time DT, connects the transistor Q2.

In some other circumstances, when the transistor Q2 is connected and the transistor Q3 is disconnected, the input power source 102 stop supplying power to the transistor Q3, and the parasitic capacitor Coss_Q2 charges the parasitic capacitor Coss_Q3 through the nodes TX_L and TX_R. In response to the parasitic capacitor Coss_Q2 charges the parasitic capacitor Coss_Q3, electric charges flow from the nodes TX_L and TX_R to the parasitic capacitor Coss_Q3 so that the voltages of the nodes TX_L and TX_R are decreased. In response to the voltages of the nodes TX_L and TX_R are decreased, the voltage of the node SW2 is increased so that the voltage of two terminals of the transistor Q5 correspondingly decreased. After the duration similar to the delay time DT, connects the transistor Q2. In other words, when the transistors Q2 and Q3 are connected, the reverse recovering voltage in a body diode of the transistor Q5 is decreased by delaying the connection of the transistors Q2 and Q3.

Operation 550 corresponds to the schematic diagram of operating the converting device 100 shown in FIG. 4B.

In operation 550, the controller 101 switches the signal PWM2 from the turn-off voltage level to the turn-on voltage level, so that the voltage Vgs_Q2 has the voltage level V0 and the transistor Q2 is disconnected.

At this moment, the voltage Vgs_Q3 has voltage level V1 and each of the voltages Vgs_Q1 and Vgs_Q4 has the voltage level V0. The voltage of the node TX_L has voltage level V_{TX}2, and the voltage Vds_Q1 has the voltage level VH. The converting device 100 continues to operation 560 after completing operation 550.

In operation 560, the controller 101 is configured to switches the signal PWM3 to the turn-off voltage level so that the voltage Vgs_Q3 has the voltage level V0 and the transistor Q3 is disconnected after the duration similar to the delay time DT when the voltage of the node TX_L has increased to the reference voltage level.

At this moment, each of the voltage Vgs_Q1, Vgs_Q2 and Vgs_Q4 has voltage level V0. The voltage of the node TX_L has the voltage level V_{TX}1, and the voltage Vds_Q1 has the voltage level VM. The converting device 100 continues to operation 570 after completing operation 560.

In operation 570, the controller 101 is configured to switches the signals PWM1 and PWM4 from the turn-off voltage level to the turn-on voltage level so that each of the voltage Vgs_Q1 and Vgs_Q4 has the voltage level V1 and the transistors Q1 and Q4 is connected.

At this moment, each of the voltages Vgs_Q2 and Vgs_Q3 has the voltage level V0. The voltage of the node TX_L has the voltage level V_{TX}2, and the voltage Vds_Q1 has the voltage level VH. The converting device 100 completes the half period of the operation 100 after completing operation 560. Wherein FIG. 3A corresponds to the schematic diagram of the converting device 100 after completing operation 570.

In some embodiments, operation 570 can also be performed by firstly connecting the transistor Q1, and secondly connecting the transistor Q4 to decrease the reverse recovering voltage of a body diode of the transistor Q6 after the duration similar to the delay time DT. Relatively, operation 570 can also be performed by firstly connecting the transistor Q4, and secondly connecting the transistor Q1 to decrease the reverse recovering voltage of a body diode of the transistor Q6 after the duration similar to the delay time DT.

Specifically, in some circumstances, when the transistor Q1 is connected and the transistor Q4 is disconnected, the parasitic capacitor Coss_Q1 is discharging to the node TX_L. In response to the parasitic capacitor Coss_Q1 is discharging to the node TX_L, the voltages of the nodes TX_R and TX_L are increased, and the discharging electric charges charge the parasitic capacitor Coss_Q4. In response to the electric charges charge the parasitic capacitor Coss_Q4, the voltage of the node SW4 starts increasing, so that the voltage of two terminals of the transistor Q6 decreases correspondingly. After the duration similar to the delay time DT, connects the transistor Q4.

In some other circumstances, when the transistor Q4 is connected and the transistor Q1 is disconnected, the input power source 102 stop supplying power to the transistor Q1, and the parasitic capacitor Coss_Q4 charges the parasitic capacitor Coss_Q1 through the nodes TX_L and TX_R. In response to the parasitic capacitor Coss_Q4 charges the parasitic capacitor Coss_Q1, electric charges flow from the nodes TX_L and TX_R to the parasitic capacitor Coss_Q1 so that the voltages of the nodes TX_L and TX_R are decreased. In response to the voltages of the nodes TX_L and TX_R are decreased, the voltage of the node SW4 is increased so that the voltage of two terminals of the transistor Q6 correspondingly decreased. After the duration similar to the delay time DT, connects the transistor Q1. In other words, when the transistors Q1 and Q4 are connected, the reverse recovering voltage in a body diode of the transistor Q6 is decreased by delaying the connection of the transistors Q1 and Q4.

In some embodiments, operations 550-570 are similar to operations 520-540. The only difference is that the operation of the transistors Q1 and Q4 and the operation of the transistors Q2 and Q3 are exchanged; however, the disclosure is not limited to this embodiment.

In some embodiments, refer to FIG. 4A and the corresponding paragraph of the disclosure, operation 520 can also be performed by disconnecting the transistor Q1 and keeping the transistor Q3 connected, resulting in the decrease of the voltage of the node TX_R; however, the disclosure is not limited to this embodiment.

In some embodiments, refer to FIG. 4C and the corresponding paragraph of the disclosure, operation 550 can also be performed by disconnecting the transistor Q3 and keeping the transistor Q2 connected, resulting in the decrease of the voltage of the node TX_L; however, the disclosure is not limited to this embodiment.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method of controlling a converting device, the method comprising:
connecting a first transistor coupled to a first node and a second transistor coupled to a second node to generate a primary current flowing from the first node through a primary coil to the second node;
generating a secondary current according to the primary current to supply power to a load; and
performing one of:
during a delayed time when the second transistor is disconnected, discharging the second node by the second transistor to decrease a voltage of the second node; and
when the voltage of the second node is adjusted to a first voltage level, disconnecting the second transistor; or
during the delayed time when the second transistor is disconnected, charging the second node by the first transistor.

2. The method of claim 1, further comprising:
when the second node has a second voltage level, disconnecting the first transistor, wherein charging the second node includes increasing the voltage of the second node to the second voltage level; and
when the first transistor is disconnected, each of the first transistor and the second transistor has the second voltage level.

3. The method of claim 2, wherein the second voltage level is higher than the first voltage level.

4. The method of claim 1, further comprising:
connecting a third transistor and a fourth transistor simultaneously; and
performing one of:
when the fourth transistor is connected and the third transistor is disconnected, discharging the first node by the fourth transistor; and
when a voltage of the first node is increased to the first voltage level, disconnecting the third transistor; or
when the third transistor is connected and the fourth transistor is disconnected, charging the first node by the third transistor; and
when the voltage of the first node is increased to a second voltage level, disconnecting the third transistor.

5. The method of claim wherein:
the third transistor is coupled to the second node and the fourth transistor is coupled to the first node,
charging the first node includes increasing the voltage of the first node to the second voltage level, and
when the third transistor is disconnected, each of the first node and the second node has the second voltage level, respectively.

6. The method of claim 1, further comprising:
when the first transistor and the second transistor are connected, decreasing a reverse recovery voltage of a diode of a fifth transistor by delaying the connection of one of the first transistor and the second transistor.

7. The method of claim 4, further comprising:
when the third transistor and the fourth transistor are connected, decreasing a reverse recovery voltage of a diode of a sixth transistor by delaying the connection of one of the third transistor and the fourth transistor.

8. A converting device, comprising:
a first transistor coupled to a first node;
a second transistor coupled to a second node; and
an input power source configured to generate a primary current that flows from the first node through a primary coil to the second node,
wherein when the second transistor is disconnected, charge the second node through the first transistor by the input power source.

9. The converting device of claim 8, wherein:
during a delayed time when the second transistor is disconnected, discharge the second node by the second transistor to decrease a voltage of the second node; and
when the voltage of the second node is adjusted to a first voltage level, disconnect the second transistor.

10. The converting device of claim 9, wherein:
when the second transistor is disconnected, the input power source is configured to increase the voltage of the second node to a second voltage level, and
when the voltage has increased to the second voltage level, the first transistor is disconnected by a controller.

11. The converting device of claim 10, wherein when the first transistor is disconnected, each of the first node and the second node has the second voltage level.

12. The converting device of claim 10, wherein the second voltage level is higher than the first voltage level.

13. The converting device of claim 10, further comprising:
a third transistor coupled to the second node,
wherein when the first transistor is disconnected, a voltage of two terminals of the third transistor starts to decrease.

14. The converting device of claim 13, further comprising:
a fourth transistor coupled to the first node,
wherein when the fourth transistor is disconnected, charge the first node through the third transistor by the input power source.

15. The converting device of claim 14, wherein:
after the third transistor and the fourth transistor are connected at a same time, disconnect the third transistor or the fourth transistor, and
when the fourth transistor is connected and the third transistor is disconnected, discharge the first node by the fourth transistor.

16. The converting device of claim 15, wherein the discharge of the first node by the fourth transistor further comprises:
when a voltage of the first node is increased to the first voltage level, disconnect the third transistor.

17. The converting device of claim 14, wherein:
after the third transistor and the fourth transistor are connected at a same time, disconnect the third transistor or the fourth transistor, and
when the third transistor is connected and the fourth transistor is disconnected, discharge the first node by the third transistor.

18. The converting device of claim 17, wherein the discharge of the first node by the third transistor further comprises:
when a voltage of the first node is increased to the second voltage level, disconnect the third transistor.

19. The converting device of claim 8, wherein:
when the first transistor and the second transistor are connected, decrease reverse recovery voltage of a diode of a fifth transistor using a delay in the connection of one of the first transistor and the second transistor.

20. The converting device of claim 14, wherein:
when the third transistor and the fourth transistor are connected, decrease reverse recovery voltage of a diode of a sixth transistor using a delay in the connection of one of the third transistor and the fourth transistor.
